(19) United States
(12) Patent Application Publication
(10) Pub. No.: US 2008/0303472 A1
(43) Pub. Date: Dec. 11, 2008

(54) METHOD FOR REPLACEMENT OF A DEFECTIVE FIELD DEVICE BY A NEW FIELD DEVICE IN A SYSTEM WHICH COMMUNICATES VIA A DIGITAL FIELDBUS, IN PARTICULAR AN AUTOMATION SYSTEM

(75) Inventors: Dirk JOHN, Karlsruhe (DE); Dominik EIFEL, Schwetzingen (DE); Frank FENGLER, Minden (DE); Georg HILSCH, Minden (DE); Stefan BOLLMEYER, Minden (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/134,325

(22) Filed: Jun. 6, 2008

(30) Foreign Application Priority Data
Jun. 8, 2007 (DE) 10 2007 026 678.4

(51) Int. Cl. G05B 19/04

(52) U.S. Cl. 318/568.2; 700/247

(57) ABSTRACT

A method for replacement of a field device to be replaced by a new field device in a system which communicates via a digital fieldbus, e.g., an automation system; wherein previous parameters, information and/or values of the field device to be replaced are compared by an electronic control unit, which communicates via the fieldbus, with parameters, information and/or values of the new field device with respect to at least one data record, in order to modify them if necessary in accordance with the field device to be replaced.

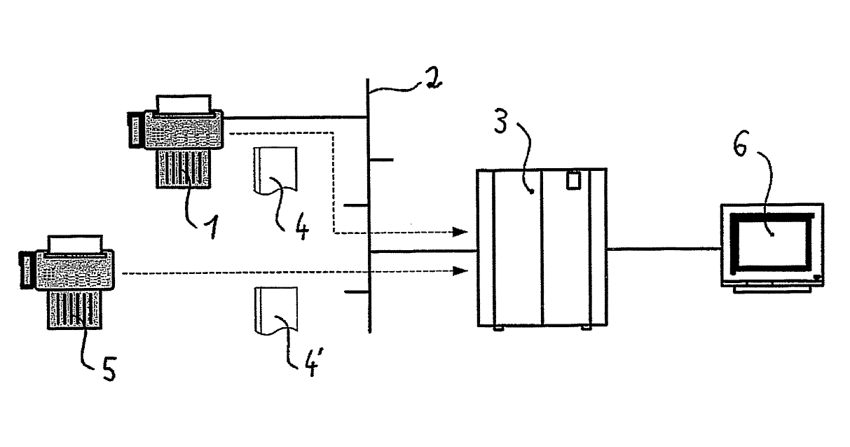

### RELATED APPLICATION

This application claims priority under 35 U.S.C. §119 to German Patent Application No. 10 2007 026 678.4 filed in Germany on Jun. 8, 2007, the entire content of which is hereby incorporated by reference in its entirety.

### TECHNICAL FIELD

The present disclosure relates to a method for replacement of a field device to be replaced by a new field device in a system which communicates via a digital fieldbus, e.g., an automation system.

### BACKGROUND INFORMATION

In automation systems which use a fieldbus for communication, higher levels of field device information are being integrated in order to modernize working processes, to improve process and product quality, and to maximize availability. Configuration and diagnosis functions of the control system likewise relate to the field devices. The expression field device relates to a large number of actuators, sensors, analysis devices and low-voltage devices which can be integrated in an automation system via a bus connection. A large number of functions can be implemented in a system by the use of intelligent field devices and the use of modern fieldbus protocols, such as control functions, setting-up functions, diagnosis functions, maintenance functions, optimization functions, alarm processing functions and life functions.

This is resulting in the trend for field devices to become ever more complex and intelligent in design and function. This is evident in the increasing number of parameters and functions of the field devices. A wide range of these parameters occur in device descriptions in the form of text, in particular, for example, in the device core data or in the device description (DD).

This device description is a database file for the field device, also referred to as a device database, specifically for PROFIBUS devices in this case. The device core data file, which is supplied by the device manufacturer, contains a description of the device. Device core data files offer the capability for an open configuration tool, in that they read the generally wide range of device information and identify the device characteristics, which are quite complex in this context. All those involved in the development of digital fieldbus solutions are familiar with the difficulty of reliably maintaining the physical device and all its characteristics throughout the entire life, to be precise starting from the selection of a suitable device type in the planning phase to its replacement in the event of repair, several years later. Inconsistencies relating to this cause additional planning effort, and can lead to relatively major failures of an entire automation system.

This results in the disadvantage that, particularly in the event of unexpected repair, the field devices generally cannot be replaced easily. Malfunctions and unplanned incompatibilities occur even in the case of field devices of the same type with the same bus protocol. This is the case even when field devices originate from the same manufacturer. A vast amount of preparatory work must therefore be carried out in order to check whether a new field device is suitable to replace a field device that needs to be replaced. This starts with checking the correct version of the firmware, device drivers and the like incorporated. Overall, a large amount of effort is required to achieve correct configuration and function selection.

One particularly problematic aspect for a new field device is the choice and use of the functionalities required for setting up. This is because each manufacturer uses different terms for essentially the same functionality and parameters. This makes the installation process highly complex and leads to incorrect configuration or function selection.

In order to solve this problem, it is known from the general prior art for manufacturers to generically use standard technical structures, variable terminology and function definitions.

### SUMMARY

Exemplary embodiments disclosed herein can make the process of replacement of field devices easier and quicker.

A method for replacement of a field device is disclosed to be replaced by a new field device in a system which communicates via a digital fieldbus, e.g., an automation system; wherein previous parameters, information and/or values of the field device to be replaced are compared by an electronic control unit, which communicates via the fieldbus, with parameters, information and/or values of the new field device with respect to at least one data record, in order to modify them if necessary to match the field device to be replaced.

In another aspect, a system is disclosed in which a method is employed for replacement of a field device to be replaced by a new field device. An exemplary system comprises an electronic control unit; and a fieldbus through which the electronic control unit communicates parameters, information and/or values of the new field device with respect to at least one data record, wherein the electronic control unit is capable of comparing previous parameters, information and/or values of the field device to be replaced, and modifying the parameters, information and/or values of the new field device with respect to at least one data record to match the field device to be replaced.

### BRIEF DESCRIPTION OF THE DRAWING

Further measures as improvements to the disclosure will be explained in the following text together with the description of one exemplary embodiment of the disclosure and with reference to a single FIGURE. The FIGURE shows a schematic illustration of a method for replacement of one field device by another in an automation system.

### DETAILED DESCRIPTION

The disclosure includes the method teaching that previous parameters, information and/or values of the field device to be replaced are compared by an electronic control unit, which communicates via the fieldbus, with parameters, information and/or values of the new field device with respect to at least one data record, in order to modify them if necessary to match the field device to be replaced.

According to the disclosure, the information used can be read from the field device under system control without any manual action, in order to use this information for installation of the new field device. This saves a considerable proportion of the labor time for installation of a new field device which, for example, is intended to replace a defective field device. This results in the complete functional range of the automation system being available again after quite a short down time.

The parameters, information and/or values which can be transmitted in the manner according to the disclosure from the field device to be replaced to the new field device preferably include the device description (DD), the device type management (DTM) or else the configuration list of the field device. A DD is created in a specific programming language, specifically the device description language (DDL). The DD allows any desired field device to be integrated in the configuration tool. For fieldbus, a CFF file is added to the DD, describing the resources implemented in the field device, for example the number of functional blocks, execution times, etc.

A device type manager (DTM) is an active software component which offers the user basic access to the configuration of a field device with a comprehensive graphics user interface. In this case, the graphics user interface for a device is always the same, irrespective of the system configuration tool being used. The DTM is normally supplied by the field device manufacturer.

A further exemplary measure as an improvement to the disclosure proposes that, before the at least one data record in the new field device is modified, the electronic control unit which is carrying out the new implementation process requests a change confirmation, to be acknowledged by the user. This measure has the advantage that the installation of the new field device can be checked by the operator by him first of all being notified of every change, and with the change being allowed only after plausibility has been checked by the operator. Complete automation of the installation process would in contrast make it difficult to become aware of any errors during the installation. Alternatively, within the scope of the present disclosure, it is also possible to carry out a comparison of the relevant parameters, information and/or values off-line before the new field device is connected in the system, in order to feed it with the required data or to supply the system with the field device data to set up the communication.

According to a further exemplary measure as an improvement to the disclosure, the installation process is simplified by first of all comparing, and if necessary changing, parameters, information and/or values which are fundamentally necessary for operation, after which ever more specific parameters, information and/or values are compared and if necessary changed. This makes it possible to ensure that all the communication-relevant parameters as well as process-relevant values and parameters, for example parameters for carrying out the major functions of process control, are first of all functional. This ensures at least a correct minimal functionality. All the other, more specific parameters, information and/or values are implemented subsequently.

An exemplary electronic control unit can possibly read the previous parameters, information and/or values from the first field device before replacement, in order to store them for the comparison process to be carried out. These parameters, information and/or values which have or has been read can be mapped in a simple manner just onto the new field device, in order to provide it with the functionality of the first field device. Any conversions required are carried out by the electronic control unit.

Another exemplary measure as an improvement to the disclosure proposes that those parameters, information and/or values which are or is not mapped onto the new field device in order to be output can be displayed via the DTM. In this case, the transferred functions can be classified as necessary and optional functions. Furthermore, it is possible to indicate whether the conversion has been successful and/or what discrepancies can be expected for the subsequent operation of the device. This allows the user to assess whether it has been possible to provide the new field device with the desired functional scope.

The FIGURE shows an exemplary field device 1 to be replaced, in the form of a pressure sensor for an automation system (which is not illustrated in any more detail) that has failed because of a defect. The field device 1 to be replaced is connected by a digital fieldbus 2, in this case PROFIBUS, to an electronic control unit 3. The previous parameters, information and/or values 4 of the field device 1 to be replaced are/is first of all read by the electronic control unit 3, which communicates via the fieldbus 2. These previous parameters, information and/or values 4 are/is compared by the electronic control unit 3 with parameters, information and/or values 4′ of a new field device 5 with respect to at least one data record. In this way, the electronic control unit 3 determines which parameters, information and/or values must be modified. Before the electronic control unit 3 changes the at least one data record in the new field device 5, the operator is in each case requested to acknowledge a change confirmation. The installation process is carried out by first of all comparing the parameters, information and/or values which are fundamentally necessary for operation, followed by ever more specific data items, with these items being modified as required. The device description (DD), the device type management (DDM), and the complete configuration list are implemented first of all, followed by ever more specific parameters, information and/or values. During this procedure, those parameters, information and/or values which result from the comparison but are not mapped onto the new field device 5 are passed from the control unit 3 to the display 6, for monitoring purposes.

The disclosure is not restricted to the exemplary embodiment described above. In fact, modifications of it are also feasible which are also covered by the scope of protection of the following claims. For example, it is also possible to replace other field devices, such as drives, motor protection units, switchgear assemblies, low-voltage devices, actuators and analysis devices in the manner according to the disclosure. Furthermore, other bus protocols, such as HART, can also be used.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

### LIST OF REFERENCE SYMBOLS

1 Field device (to be replaced)
2 Fieldbus
3 Electronic control unit
4 Parameters, information and/or values (data records)
5 Field device (new)
6 Display

What is claimed is:

1. A method for replacement of a field device to be replaced by a new field device in a system, the method comprising:
previous parameters, information and/or values of the field device to be replaced are compared by an electronic control unit, which communicates via the fieldbus, with parameters, information and/or values of the new field device with respect to at least one data record, in order to modify them if necessary to match the field device to be replaced.

2. The method as claimed in claim 1, wherein
the parameters, information and/or values comprise the device description (DD), the device type management (DTM), the configuration list.

3. The method as claimed in claim 1, wherein
a change confirmation to be acknowledged by the operator is requested by the electronic control unit before any change to the at least one data record in the new field device.

4. The method as claimed in claim 1, wherein
the comparison of the relevant parameters, information and/or values is carried out off-line.

5. The method as claimed in claim 1, wherein
first of all parameters, information and/or values which are fundamentally necessary for operation are compared, and if necessary changed, after which ever more specific parameters, information and/or values are compared and if necessary changed.

6. The method as claimed in claim 1, wherein
the electronic control unit reads the previous parameters, information and/or values of the first field device before replacement, in order to store them for the comparison to be carried out.

7. The method as claimed in claim 6, wherein
the parameters, information and/or values that have been read from the first field device are mapped onto the new field device.

8. The method as claimed in claim 1, wherein
the parameters, information and/or values which are not mapped onto the new field device are output to the display.

9. The method as claimed in claim 1, wherein the system communicates via a digital fieldbus.

10. The method as claimed in claim 1, wherein the system is an automation system.

11. A system in which a method is employed for replacement of a field device to be replaced by a new field device, comprising:
an electronic control unit; and
a fieldbus through which the electronic control unit communicates parameters, information and/or values of the new field device with respect to at least one data record, wherein the electronic control unit is capable of comparing previous parameters, information and/or values of the field device to be replaced, and modifying the parameters, information and/or values of the new field device with respect to at least one data record to match the field device to be replaced.
